(19) United States
(12) Patent Application Publication
(10) Pub. No.: US 2012/0175005 A1
(43) Pub. Date: Jul. 12, 2012

(54) CONDUIT AND SYSTEMS

(75) Inventor: Jacob Andersen, Liberty Lake, WA (US)

(73) Assignee: Andersen Holdings, LLC., Liberty Lake, WA (US)

(21) Appl. No.: 12/986,685

(22) Filed: Jan. 7, 2011

(51) Int. Cl. F16L 55/00

(52) U.S. Cl. 138/104

(57) ABSTRACT

Disclosed herein are conduits and systems. According to an implementation, a conduit may have a conduit layer and one or more detection components within the conduit layer. The one or more detection components are configured to detect when the conduit is damaged. The conduit may be provided upon or within a pre-existing conduit component such that the conduit provides notification when the conduit has been damaged or severed prior to the conduit component being damaged or severed.

### BACKGROUND

Conduits, such as tubes, pipes, tiles, ducts, lines, and so forth are well known for use in holding, containing, and/or transporting solid, liquid, and gaseous materials. For example, a conduit may be a rigid or flexible pipe containing conduits or wire. A conduit may alternatively be used to transport a gas or liquid, such as crude oil, hydraulic fluid, compressed gas and so forth. A conduit may have any of various characteristics. For example, a conduit may have a cylindrical shape with a round cross-section or may have an oval, square, polyhedron or other suitable shaped cross-section. The conduit may be rigid, semi-rigid, or flexible.

Conventional conduits are generally not equipped to automatically provide notification of damage to the conduit. Thus, if a portion of the conduit is damaged, there is typically no knowledge of the damage until some catastrophic event occurs or until the conduit is manually inspected for damage. Damage may be caused by a cutting action or may be the result of incidental wearing or cutting, such as if the conduit is struck during a digging process or if excessive wear occurs due to environmental effects. Manual inspection may not be practical, particularly where security, safety, or reliability are involved or in instances where long lengths of conduit are being monitored.

### BRIEF DESCRIPTION OF DRAWINGS

FIG. 1A is a schematic view of an exemplary conduit system for detecting a wearing or cutting of the conduit.

FIG. 1B is a schematic view of an exemplary conduit system for detecting a wearing or cutting of the conduit.

FIG. 1C is a schematic view of an exemplary conduit system for detecting a wearing or cutting of the conduit.

FIG. 1D is a schematic view of an exemplary conduit system for detecting a wearing or cutting of the conduit.

FIG. 2A is a schematic diagram of a conduit system illustrating an example of the placement of detection components.

FIG. 2B is a schematic diagram of a conduit system illustrating an example of the placement of detection components.

FIG. 2C is a schematic diagram of a conduit system illustrating an example of the placement of detection components.

FIG. 3 is a schematic diagram of an example electrical circuit that may be used for a conduit system.

In the following detailed description, reference is made to the accompanying schematic drawings, which form a part hereof. The use of the same symbols in different drawings typically indicates similar or identical items. The illustrative embodiments described in the detailed description, drawings, and claims are provided merely for illustration and are not meant to be limiting. Other embodiments may be utilized, and other changes may be made, without departing from the spirit or scope of the subject matter presented here.

### DETAILED DESCRIPTION

The present disclosure provides conduits and systems. While examples of these are described for purposes of convenience of understanding, the disclosure is not intended to be limited by the exemplary descriptions provided herein.

According to an implementation, a conduit is disclosed having at least one detection component. One or more detection components are configured to provide notification when the detection component(s) has/have been damaged, which may be indicative of the conduit being damaged. The detection component may be integrated with the conduit, placed around the conduit, and/or placed inside the conduit. The detection component may comprise one or more electric wires and/or fiber optic strands to detect wearing or cutting of the conduit. Moreover, the detection component may extend along a portion or the entire length of the conduit.

According to an implementation, a conduit system includes a conduit and a monitoring component. The monitoring component may sense damage to the conduit prior to catastrophic damage of the conduit via one or more detection components. The monitoring component may notify an owner, user, or maintainer of the conduit of the damage.

According to an implementation, a sheath is provided that is configured to fit around a conduit component. The sheath utilizes one or more detection components to provide notification that the sheath has been damaged. The damage may be repaired or addressed, and/or an alarm may be activated, prior to damage, particularly catastrophic damage, occurring to the underlying conduit component.

According to an implementation, a conduit liner is provided that is configured to fit within a conduit component. The liner utilizes one or more detection components to provide notification that the liner has been damaged. The damage may be repaired or addressed, and/or an alarm may be activated, prior to damage, particularly catastrophic damage, occurring to the overlying conduit component.

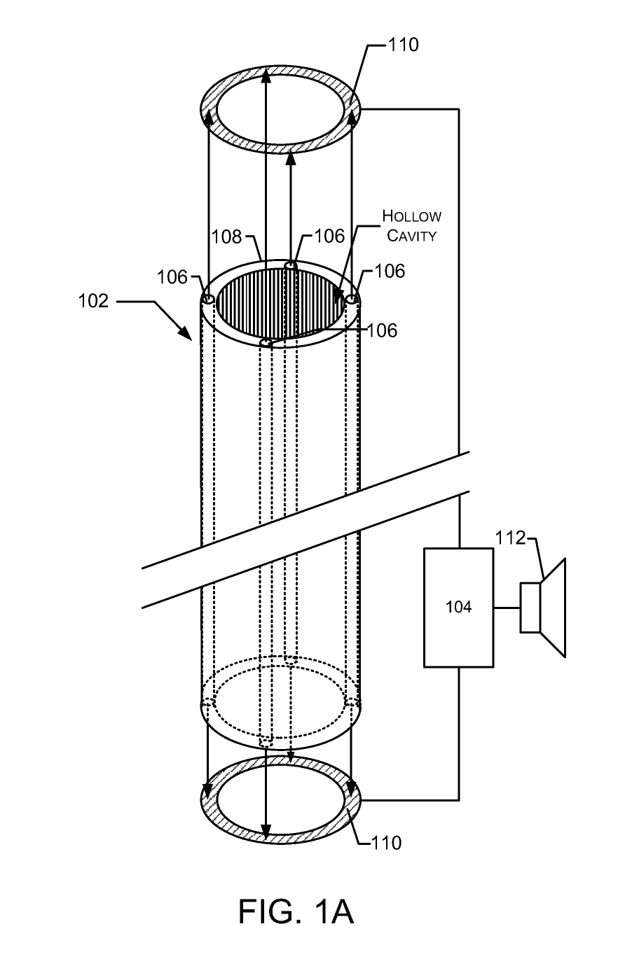

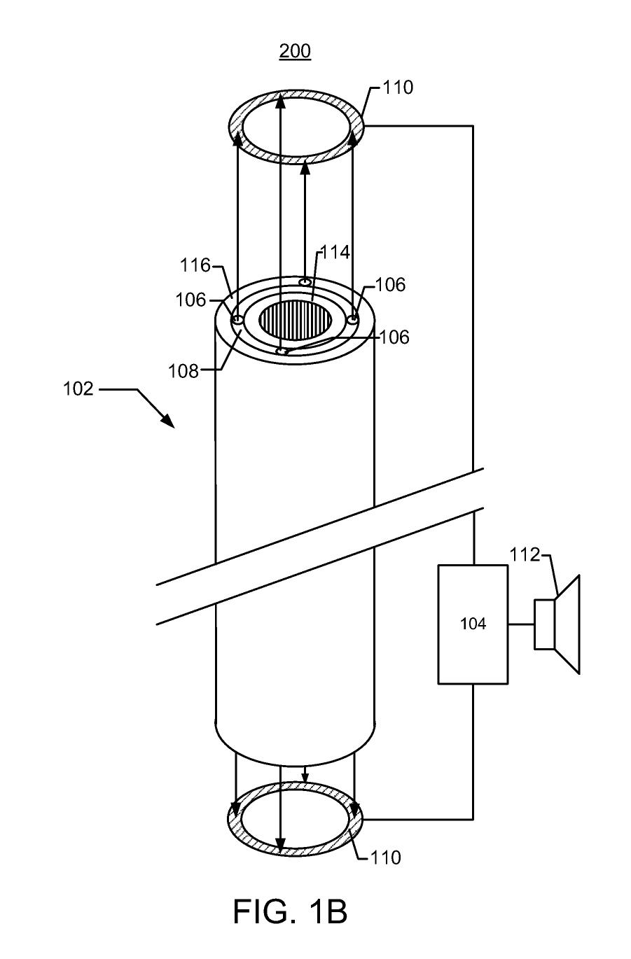

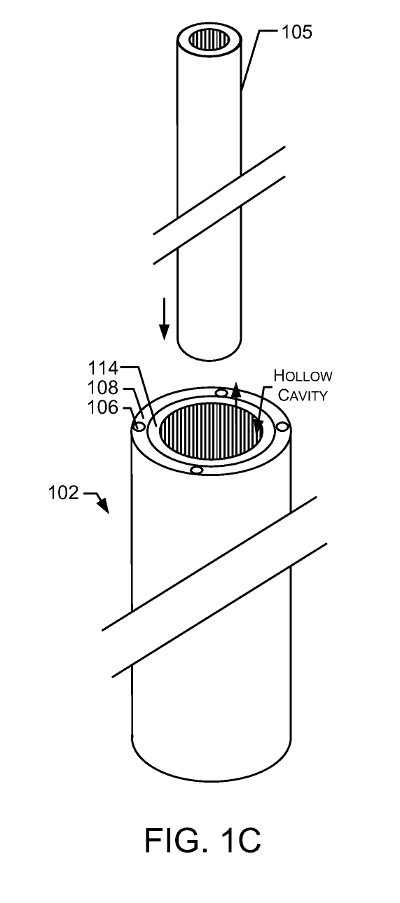

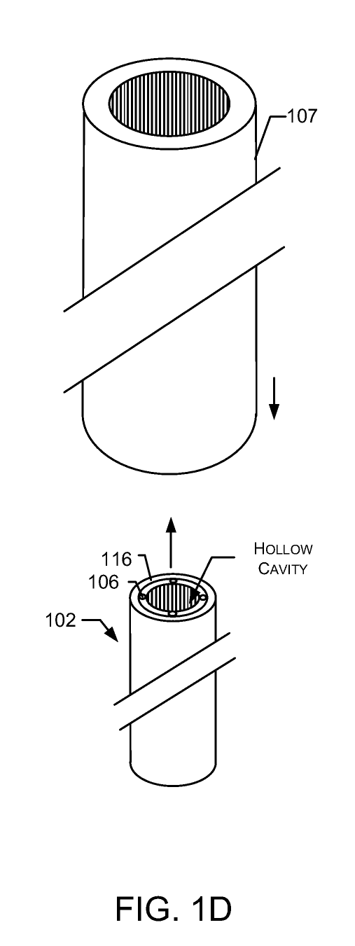

FIG. 1 shows a cutaway view of an exemplary conduit 102. According to this implementation, the conduit 102 may have a central cavity which may be used for holding, containing, and/or transporting solid, liquid, and gaseous materials and/components. The conduit 102 may be a rigid or flexible pipe or hose containing further conduits or wire within a hollow cavity. The conduit may additionally or alternatively be used to transport a gas or liquid, such as crude oil, hydraulic fluid, compressed gas and so forth. The conduit 102 is shown having a cylindrical shape with a round cross-section; however, the conduit 102 may alternatively have an oval, square, polyhedron, irregular, or other suitable shaped cross-section. The conduit 102 may be rigid, semi-rigid, or flexible.

The conduit 102 is provided with a plurality of detection components 106, which may be one or more electrical wires. While FIG. 1 shows a single wire for each of the detection components 106, the implementation is not so limited. The number and placement of detection components 106, as well as the number of electrical wires used for each detection component, may be adjusted based on the application and other design considerations. Moreover, detection components 106 are shown extending only in a longitudinally linear fashion. However, in the case that multiple conduits or wires are utilized for the detection component 106, the individual wires or conduits may be twisted, braided, or otherwise aligned and/or intertwined. Moreover, the detection components 106 may extend along any portion or an entire length of the conduit 102. Thus, the detection components 106 may be provided in regions of extraordinary wear or elsewhere on the conduit 102.

According to the implementation shown in FIG. 1, at least one detection component 106 is placed between the hollow cavity of the conduit 102 and the outside environment. More particularly, the detection component 106 may be inserted or formed within a conduit layer 108, which may be formed, molded, extruded, or otherwise constructed of one or more layers of Kevlar™, available from the Dupont Corporation of Wilmington, Del., a thermoplastic polyethelene, nylon, rubber, carbon mesh, metal, plastic, aggregate, composite, ceramic, or other suitable material. Thus, as cutting or wearing occurs to the conduit layer 108 or, more generally, as environmental wear occurs on the conduit 102 as a whole, the at least one detection component 106 is severed or cut. According to an example, the detection components 106 are integrated with the conduit layer 108 during a molding process. One skilled in the art will appreciate that the detection components 106 could be formed on or within the conduit layer 108.

The detection component 106 may be configured to be monitored by a monitoring component 104. The monitoring component 104 may be configured to sense a change in an electrical property of the detection components 106 via contacts 110. According to this implementation, the monitoring component 204 provides a voltage or current to the one or more electrical wire detection components 106 and monitors an electrical characteristic of the electrical wire(s) 106 resulting from the applied voltage or current. Additionally or alternatively, one or more detection components 106 may be implemented using fiber optic cables, in which case, the monitoring component 104 may sense a change in a light characteristic of the fiber optic detection components 106. The monitoring component 104 may provide notification to a user, owner, or maintainer of the conduit according to well known wired and/or wireless techniques. Additionally, the monitoring component may include or be connected to an alarm component 112, which may provide a visible, audible, or other sensory alarm locally and/or remotely to conduit 102 and/or monitoring component 104 in order to indicate that monitoring component 104 has detected a change with respect to one or more of the electrical (or fiber optic) wire detection components 106. The conduit layer 108 and the detection component 106 may each or both provide tensile and/or shear strength to the conduit 102.

As shown in FIG. 1B, the conduit 102 may further comprise an inner reinforcement layer 114 and/or an outer reinforcement layer 116, which may be within or upon conduit layer 108, respectively. Layers 114 and/or 116 may include one or more layers of a cut resistant and/or wear resistant material that may be configured to prevent or delay catastrophic wearing, shearing, or cutting of the conduit 102. Layers 114 and/or 116 may include one or more metal layers or components such as a titanium, stainless steel, etc. and/or a fibrous material such as Kevlar™, available from the Dupont Corporation of Wilmington, Del., a thermoplastic polyethelene, nylon, or other suitable material.

The one or more detection components 106 may be provided in, around, or along conduit layer 108. If implemented as one or more electrical wires, detection components 106 may have an electrically insulating coating to isolate or shield adjacent electrical wires from each other and from any surrounding environment. If implemented as one or more fiber optic conduits, detection component 106 may have a light reflecting or shielding coating to isolate or shield adjacent fiber optic conduits from each other and from any surrounding environment.

According the exemplary implementations shown and described with respect to in FIG. 1B, the conduit 102 would advantageously require several cut or wear attempts to completely sever the conduit 102 due to the multiple layers.

According to an implementation, the electrical wire detection components 106 are provided on or near a peripheral region of the conduit 102 so that the alarm is activated during the first stage of wear or cutting from the outside environment.

According to a further implementation, the monitoring component 104 may be coupled to control a security device, such as a security camera, (not shown) to activate an automated response such as activating a security camera to take photos or video of the area where the detection component 106 has been severed. Such an implementation may be combined with the alarm component 112 such that a visual and or audible alarm is triggered, a security camera is activated, and/or an owner, user, or maintainer of the conduit 102 is notified. The audible alarm component 112 local to the conduit may be particularly useful in the case where the conduit 102 contains hazardous materials as persons in the area may be notified that at least one detection component has been severed and those persons may leave the area to avoid exposure to the hazardous material.

The conduit 102 may similarly be used for a communication conduit for housing an electrical cable or wire and/or fiber optic cable or wire. Thus, if excessive wear or a cut is detected using detection components 106, the conduit 102 may be inspected or otherwise addressed by the conduit owner, user, or maintainer prior to damage occurring to the electrical or fiber optic cables or wires within the conduit 102. Such early detection may prevent any signal loss across the electrical or fiber optic cables or wires. Moreover, such early detection may prevent fire or electrocution dangers that would be caused if electrical cables or wires within the conduit 102 were exposed or cut.

As indicated above, the one or more detection components 106 may be implemented as fiber optic conduits. The monitoring component 104 may sense or detect a characteristic of light traveling through the fiber optic conduit detection components 106. The monitoring component 104 may be configured to provide notification if a change in the characteristic of the light is detected. The light passing through fiber optic conduit detection components 106 may be generated by the monitoring component 204 or may be provided by another source as will be appreciated by one skilled in the art.

FIG. 1C shows an implementation of a conduit 102 for fitting around an existing conduit component 105. According to this implementation, the conduit component 105 may be provided as a conventional conduit, cable, or wire, such as a conventional or pre-existing fiber optic cable or bundle, electricity transmission cable or bundle, a conduit for the containment or transportation of solids, fluids or gases, or the like. Detection components 106 may be used to sense wearing or cutting to the outside of the conduit 102 prior to damage occurring to conduit component 105. The conduit 102 may be provided in the form of a sheath that may be pulled over, pushed around, or formed upon the conduit component 105. Intermediate layers, such as inner reinforcement layer 114 may additionally be provided to protect the conduit component 105. The detection components 106 may be used consistent with the other implementations described herein in order to provide notification when the detection components 106 have been damaged. Thus, damage may be repaired or addressed, and/or an alarm may be activated, prior to damage, particularly catastrophic damage, occurring to the underlying conduit component 105.

FIG. 1D shows an implementation of a conduit 102 for fitting within an existing conduit component 107. According to this implementation, the conduit component 107 may be provided as a conventional conduit, such as a conventional or pre-existing conduit used to contain or transport solids, fluids, and/or gases, or the like. Detection components 106 may be used to sense wearing or cutting to the inside of the conduit 102 prior to damage occurring to conduit component 107. The conduit 102 may be pulled or pushed into or formed within the conduit component 107. Intermediate layers, such as outer reinforcement layer 116 may additionally be provided to protect the conduit component 107. The detection components 106 may be used consistent with the other implementations described herein in order to provide notification when the detection components 106 have been damaged. Thus, damage may be repaired or addressed, and/or an alarm may be activated, prior to damage, particularly catastrophic damage, occurring to the underlying conduit component 107.

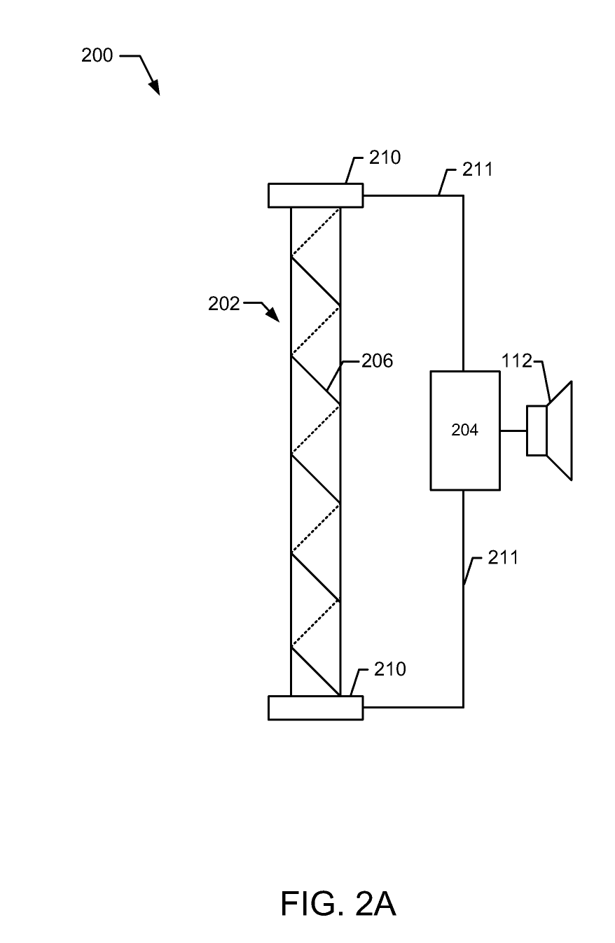

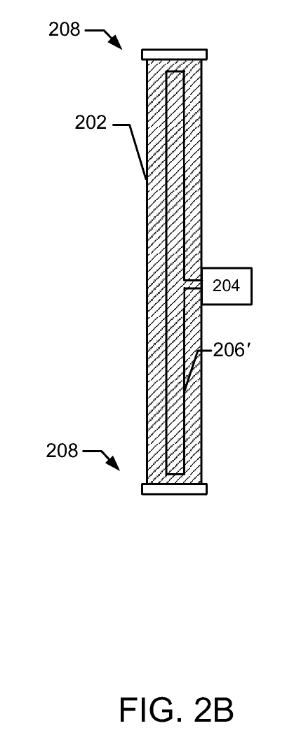

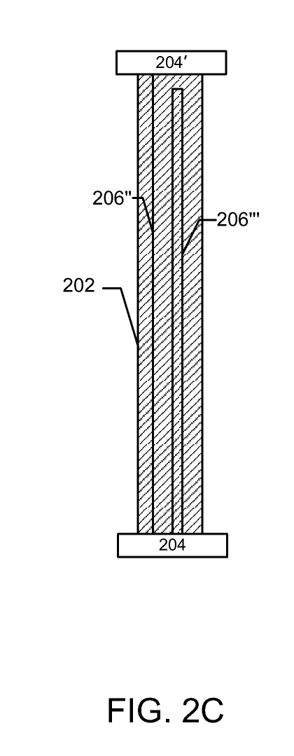

FIG. 2A shows an implementation of a conduit monitoring system 200. The security conduit system 200 includes a conduit 202 and a monitoring component 204 coupled to an electrical wire detection component 206.

The monitoring component 204 may be configured to sense cuts or breaks in conduit 202. As described with respect to FIGS. 1A-C, the conduit 202 may have one or more reinforcement layers 114 and 116 to reduce the likelihood of a single event severing the entire conduit 202. As shown in FIG. 2A, electrical wire detection component 206 may be helically wound around or near an inner or outer perimeter of the conduit 202 (where dotted lines represent the detection component 206 extending behind the conduit 202 in the field of view). Each of the two ends of the electrical wire detection component 206 is connected in an electrical circuit monitored by the monitoring component 204 via contacts 210, where the electrical circuit may include wires 211 to couple the electrical wire detection component 206 to the monitoring component 204. If wear or cutting occurs to the outside of the conduit 202, the electrical wire detection component 206 is severed before underlying wires, layers, and/or inner layers, such as layer 114 of conduit 202. If wear or cutting occurs to the inside of the conduit 202, the electrical wire detection component 206 is severed before the outer reinforcement layer 114 of conduit 202. Thus, integrity of the conduit 202 may be maintained even though detection component 206 may be severed due to wear or cutting. The monitoring component 204 may sense that the circuit formed between the monitoring component 204 and the detection component 206 is disturbed and may remotely notify the owner, user, or maintainer of the conduit and/or may initiate an audible, visible, or other sensory alarm locally or remotely to allow persons to vacate the area or to allow a owner, user, or maintainer of the conduit 202 to address the wearing or cutting prior to catastrophic failure of the conduit 202.

As mentioned above, the detection component may extend helically or linearly along the conduit. In the event that the conduit is configured to include multiple electrical wire detection components to be monitored by the monitoring component, the electrical wires may be placed in a number of configurations. For example, one or more of the electrical wires may be twisted, spiraled, coiled, or helically wound along the length of the conduit. Additionally or alternatively, one or more of the electrical wires may extend generally linearly in a loop along the conduit 202, as shown in FIGS. 2B. One or more circuits may thus be made with electrical wire detection components 206′ running along the length of the conduit. Although only one detection component 206′ is shown in FIG. 2B for the sake of simplicity, additional detection components and circuits may be included.

One skilled in the art will appreciate that the wiring configuration shown in FIG. 2B may be modified on an application specific basis. For example, as shown in FIG. 2C, the monitoring component 204 may interface with conduit 202 at any point along the conduit 202 and/or may interface with the detection components, e.g. 206″, at both ends of the conduit 202. Additionally or alternatively, the electrical wire detection component 206′″, may interface with only one end of conduit 202.

According to the implementation shown in FIG. 2C, a first end of the conduit 202 has a first contact for connecting a first end of one or more electrical wire detection components 206′ and/or 206′″ to a first sensing portion or contact of the monitoring component 204. A second end of the conduit 202 may additionally have a second contact (i.e., in the case of 206″) for connecting a second end of one or more of the electrical wires 206″ to a second end of the monitoring component 204′. Thus, the monitoring components 204 and 204′ may work singularly or together to monitor the components 206″ and/or 206′″ as will be appreciated by one skilled in the art.

According to an implementation, the monitoring component 204 (or 104) may be activated and monitored locally at the location of the conduit, or may be activated and/or monitored remotely using a software and/or hardware interface to sensing the integrity of the electrical wires detection component(s), e.g. 106.

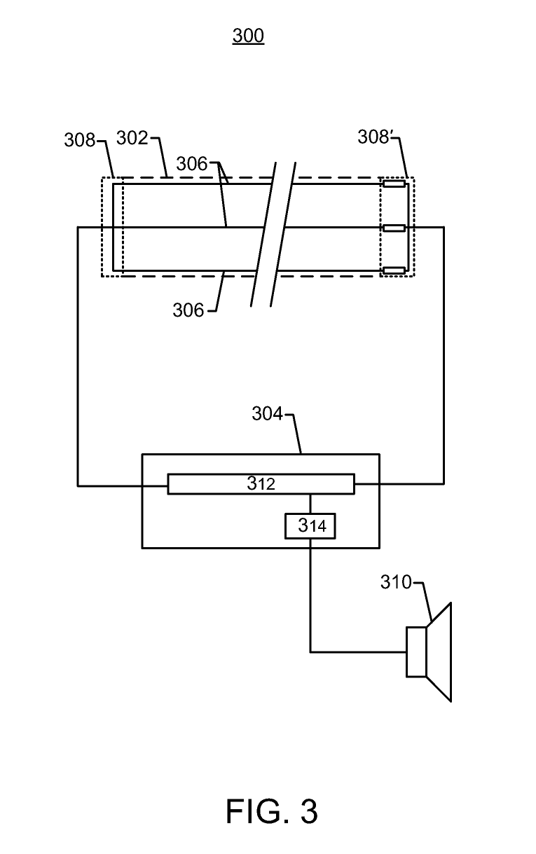

FIG. 3 shows an example circuit 300 implemented with a conduit 302 (shown in dashed line). A monitoring component 304 may be utilized to monitor electrical wire implemented detection components 306 placed within or upon conduit 302. The monitoring component 304 may be coupled to detection components 306 via contacts 308 and 308′ (shown in dotted lines). The monitoring component 304 measures the resistance of the circuit loop, whether it be a single loop or a parallel sum of resistances for more than one loop.

According to one implementation, the monitoring component 304 measures resistance using analog techniques. According to this implementation, a “latched” condition may be created for each of the detection components 306 that are part of the circuit. The detection components 306 may be coupled with an analog relay, which provides a relatively constant system resistance. When one of the detection components 306 is severed, that detection component 306 creates an “unlatched” state which is sent through component 312, which may be a relay, to a processing component 314, such as a processor or other suitable mechanism associated with monitoring component 304. The processor 314 senses the change in resistance caused by the “unlatched” state of the detection component 306, which may in turn cause the alarm component 310 to be triggered.

According to an alternative implementation, the monitoring component 304 measures resistance using digital techniques. According to this implementation, a “latched” condition may be created for each of the detection components 306 that are part of the circuit. The detection components 306 may be coupled to provide a relatively constant system resistance. When one of the detection components 306 is severed, that detection component 306 creates an “unlatched” state which is sent through component 312, which may be an analog to digital (A-D) converter, to a processing component 314, such as a processor or other suitable mechanism associated with monitoring component 304. The A-D converter of component 312 may generate digital output reflecting the system resistance. The processor 314 senses a change in the digital value output by the A-D converter caused by the “unlatched” state of the detection component 306, which may in turn cause the alarm component 310 to be triggered.

The circuit 300 may also be an analog/digital circuit that senses the resistance of the alarm circuit or the continuity of the alarm wire(s) and generates one or more data formats of digital output with information about the state of the detection components 306. For example, component 312 may be an A-D converter that senses the state of the detection components 306, where a resistance of a certain value will yield digital output 0000. The processor may continuously or at chosen intervals check the digital output from the A-D converter and match it to a pre-programmed threshold or thresholds. The digital output of the A-D converter changes based on the number of detection components 306 that have been cut or damaged and, in response to such an event, the A-D converter gives the programmed data or alarm response to a computer or monitoring system for further processing or to trigger additional responses.

Additionally or alternatively, the circuit 300 may be fully digital and controlled by a remote or host computer (not shown) that monitors the resistance or integrity of each wire detection component 306. The resistance of the wires may be sensed to generate output data. The data may be multiplexed and formatted to be sent via one or more digital formats by either wired of wireless data transfer to a remote computer or monitor system where the remote system determines the integrity of the electrical wire detection components 306.

The processor 314 may be configured to sense threshold values such that a different alarm or notification may be provided based on the number of detection components that have been severed. Additionally or alternatively, the processor 314 may be programmed to “disable” or ignore the effects of a faulty detection component 306. Additionally or alternatively, the processor 314 may be programmed to ignore minor changes or short term changes in resistance, capacitance, voltage, current, or other electrical characteristic including data transmitted. The processor 314 may output a signal to an alarm, communication device, remote and/or mobile device, other computer and so forth.

The monitoring component 304 may monitor the integrity of the electrical wire detection components 306 by continuously measuring conductivity, resistance, or other electrical characteristic of each individual wire circuit or by measuring the conductivity, resistance, or other electrical characteristic of each individual wire detection component 306 compared to a common conductor. The monitoring component 304 may direct the alarm component 310, such as a local alarm, security information alarm system, site security, and/or remote monitoring system, that the exterior integrity of the conduit 302 has been compromised-due to a breach of one or more of the electrical wire detection components 306—thus triggering an alarm or notification condition. The alarm component 310 may provide (or cause to be provided) a visible alert, an audible alert, or both, to an area proximate to the conduit 502. Additionally or alternatively, the alarm may be a visible and/or audible alert provided to the owner, user, and/or maintainer of the conduit 302.

### Conclusion

Undoubtedly, numerous variations and modifications of the invention will become readily apparent to those familiar with conduits and electrical monitoring systems. Although implementations of the conduit and monitoring systems have been described in language specific to structural features and/or methodological acts, it is to be understood that the system and method defined in the appended claims is not necessarily limited to the specific features or acts described. Rather, the specific features and acts are disclosed as exemplary forms of implementing the claims.

What is claimed is:

1. A conduit comprising:
a conduit layer; and
one or more detection components within the conduit layer, the one or more detection components configured to detect when the conduit is damaged.

2. The conduit of claim 1, further comprising a reinforcement layer provided on an outer portion of the conduit layer.

3. The conduit of claim 1, further comprising a reinforcement layer provided on an inner portion of the conduit layer.

4. The conduit of claim 1, wherein the one or more detection components comprises one or more electrical wires connected in a circuit with a monitoring component, the monitoring component configured to sense a change in the circuit due to damage to one or more of the one or more wires.

5. The conduit of claim 4, wherein the one or more electrical wires extend helically along the conduit layer.

6. The conduit of claim 1, wherein the one or more detection components comprise a plurality of electrical wires connected in parallel in a circuit with a monitoring component, the monitoring component configured to sense a change in the circuit due to damage to one of the plurality of electrical wires.

7. The conduit of claim 1, wherein the one or more detection components comprise one or more fiber optic wires connected to a monitoring component, the monitoring component configured to sense a change in a light characteristic due to damage to the one or more fiber optic wires.

8. A conduit system comprising:
a conduit including a conduit layer and one or more detection components within the conduit layer; and
a monitoring component configured to determine whether the one or more detection components is damaged or severed.

9. The conduit system according to claim 8, wherein the one or more detection components extend along the longitudinal direction of the conduit, wherein the one or more detection components is provided on an outer perimeter region of the conduit, the conduit further comprising a hollow cavity and an inner reinforcement layer on the inner cavity portion of the conduit.

10. The conduit system according to claim 8, wherein the monitoring component is configured to detect that at least one of the one or more detection components is damaged or severed prior to the inner reinforcement layer being damaged or severed.

11. The conduit system of claim 8, wherein the monitoring component is configured to activate an alarm component.

12. The conduit system of claim 10, wherein the alarm component activates a visible alarm, an audible alarm or both a visible alarm and an audible alarm in a region local to the conduit.

13. The conduit system of claim 10, wherein the alarm component activates a visible alarm, an audible alarm or both a visible alarm and an audible alarm in a region remote from the conduit.

14. The conduit system according to claim 8, wherein the conduit further comprises an outer reinforcement layer around the outer portion of the conduit.

15. The conduit system according to claim 8, wherein the conduit includes a plurality of detection components within the conduit layer and wherein the monitoring component is configured to determine whether one of the detection components is damaged or severed.

16. The conduit system according to claim 15, wherein the monitoring component is configured to determine the number of detection components that are damaged or severed.

17. A conduit configured to be provided on an inner portion or an outer portion of a pre-existing conduit component, the conduit comprising a conduit layer and one or more detection components within the conduit layer, the one or more detection components configured to detect when the conduit is damaged.

18. The conduit according to claim 17, wherein the conduit is configured to be provided on an outer portion of a pre-existing conduit component, the conduit further comprising an inner reinforcement layer between the conduit and the pre-existing conduit component.

19. The conduit according to claim 17, wherein the conduit is configured to be provided on an inner portion of a pre-existing conduit component, the conduit further comprising an outer reinforcement layer between the conduit and the pre-existing conduit component.

20. The conduit according to claim 17, wherein the one or more detection components comprise one or more electrical wires extending along the longitudinal direction of the conduit, wherein the one or more electrical wires are provided as one or more electrical circuits coupled to a monitoring component, wherein the monitoring component is configured to detect a change in the one or more electrical circuits due to at least one of the one or more electrical wires being severed or damaged.
